(19) United States
(12) Patent Application Publication
(10) Pub. No.: US 2017/0116522 A1
(43) Pub. Date: Apr. 27, 2017

(54) Method For Task Scheduling And Resources Allocation And System Thereof

(71) Applicant: Telekom Malaysia Berhad, Kuala Lumpur (MY)

(72) Inventors: Sahrul Hilmi Ibrahim, Kajang (MY); Ahmad Abdulsalam Bin Ahmad Fatan, Pagoh (MY); Surjya Narayana Padhi, Seri Petaling (MY); Muhamad Noh Bin Ismail, Kajang (MY); Mohammad Shazri Bin Shahrir, Puchong (MY); Sevia Mahdaliza Idrus Sutan Nameh, Johor Bahru (MY); Noor Fazilatulakma Bt. Mohd Zaini, Ipoh (MY)

(73) Assignee: Telekom Malaysia Berhad, Kuala Lumpur (MY)

(21) Appl. No.: 15/280,353

(22) Filed: Sep. 29, 2016

(30) Foreign Application Priority Data
Oct. 5, 2015 (MY) PI 2015002496

(51) Int. Cl. G06N 3/12

(52) U.S. Cl. CPC G06N 3/126

(57) ABSTRACT

A system and method for automatically assigning multiple tasks with multiple objectives to multiple teams (group of technician on field) is provided. This invention provides a means to minimize total operation cost and business process through the optimization consisting of the best assignment of resources to available task. In the tasks assignment and resource allocation method disclosed herein, new genetically adapted search agent (Genetic algorithm) are employed to improve the population, to provide the most optimum match matrix among jobs and teams, and calculate the best score of the fittest chromosome. The assignments generated by this method satisfy all constraints.

### CROSS-REFERENCE TO RELATED APPLICATIONS

The present application claims the priority benefit of Malaysian Patent Application No. PI 2015002496, filed Oct. 5, 2015, which is incorporated by reference in its entirety.

### FIELD OF INVENTION

The invention relates to a task scheduling system and method. More particularly, the invention relates to an automation system and method in assigning duties to a group of workers via an improved genetic algorithm that satisfies all constraints.

### BACKGROUND OF THE INVENTION

Planning and scheduling are important in the telecommunication sector. A big demand to broadband services causes the internet service provider (ISP) to increase investment in new equipment, and upgrade older infrastructure into a better one in order to widen the coverage and improve service performance. The increase of demand in either the installation of new infrastructure or the maintenance of servers causes the number of possible courses of action and the ways to allocate resources to become overwhelmed.

One of the main objectives of an ISP is to ensure the service given to their customer or subscriber complies with the service-level-agreement (SLA). For any complaints or trouble ticket which cannot be resolved via a call to the service center, a repair team is dispatched to perform an on-site evaluation and repair. Managing a large amount of repair teams and cases is a complicated task and requires a good algorithm to compute an optimized solution for resource allocation and task scheduling. Although several automated methods have been implemented in Telekom Malaysia (TM), the operators still have to rely on the manual system due to the complexities of received cases. The complexities are referring to the types of service, types of customer, priority of cases, repeat complaint, etc. This is due to most of the present method only focusing on fixed constraints and fixed target locations.

Therefore, a need exists to design an engine based on an improved genetic algorithm to overcome the aforementioned drawbacks and to replace the prior manual task assignment system with a fully automated engine that can assign multiple tasks with multiple objectives to multiple groups of workers. The present invention provides such a method and system thereof.

### SUMMARY OF INVENTION

The invention provides a computer implemented method for assigning tasks to a group of workers including the steps of retrieving, by a data retrieval module, information relating to a set of activities to be executed, a set resources to be utilized during the execution of the activities, a set of constraints to be satisfied, and a set of objectives to be accomplished from a database; assigning, by a weight assigning module, a weight value according to the set of constraints for each of the activities; sorting, by a task sorting module, the activities according to each of their respective weight value; assigning, by the task sorting module, at least one resource to each of the activities; generating, by a match matrix generator, a matrix carrying the list of activities with their corresponding resource assigned; and applying, by a genetic algorithm module, a genetic algorithm process on the generated matrix to produce an optimum solution for the assignment of the at least one resource to each of the activities.

Preferably, the genetic algorithm process includes the steps of generating a plurality rows of initial population, wherein each row of the initial population corresponds to one chromosome in a genetic algorithm, and each activity in the row of the initial population corresponds to a gene in the genetic algorithm, forming a fitness function based on the initial population to acquire fitness values of the chromosomes, selecting an optimum fitness value by using roulette wheel selection, performing a chromosome crossover process and a mutation process to generate new and mutated sets of chromosomes, executing an iteration process on the chromosome crossover process and the mutation process until a predetermined maximum repetition value is reached so as to obtain an optimum chromosome, and outputting the outcomes of the genetic algorithm process to a display unit.

Alternatively, the step of sorting the activities is according to descending order of the weights.

Preferably, the chromosome crossover process includes the steps of defining the crossover rate, randomly assigning a chromosome value for the crossover process, defining the crossover point, executing the recombination process of genes based on the defined parameters, and updating the recombined chromosome to the population.

Preferably, the mutation process includes the steps of defining the mutation rate, randomly generating a value for the gene, defining the mutation point, executing the replacement of generated value according to the defined parameter, and updating the mutated chromosome to the population.

Preferably, the output process includes the steps of generating a task schedule chart which illustrates timeline, resources, priority for each activity, and computing distance score, priority serving score, balance score, and total fitness value.

At least one of the preceding objects is met, in whole or in part, by the invention, in which the embodiment of the invention discloses an automated system for assigning tasks to a group of workers includes a service server connected to a communication network, and coupled with at least one database; and a data mining engine connected to the service server via the communication network, and configured to retrieve data from the database, assigning weight value to the retrieved data, sorting the data according to each of their respective weight value, processing the sorted data via a genetic algorithm to produce an optimum solution for the task assignment, and transmit the optimum solution to at least one electronic device via the communication network.

Preferably, the data mining engine includes a data retrieval module configured to retrieve data from the database of the service server, a weight assigning module configured to assign a weight value to the retrieved data, a task sorting module configured to sort the data according to each of their assigned weight value, a match matrix generator configured to generate a match matrix according to the sorted data, and a genetic algorithm module configured to apply the genetic algorithm process on the generated matrix to produce an optimum solution for the assignment of tasks.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is are illustrated in the accompanying drawing the preferred embodiments from an inspection of which when considered in connection with the following description, the invention, its construction and operation and many of its advantages would be readily understood and appreciated.

FIG. 1 is a schematic diagram illustrating the general architecture of the system which embodies therein the principle features of the invention.

FIG. 2 is a flowchart illustrating the main process of an auto-assignment engine for task scheduling and resources allocation.

FIG. 3 is a flowchart illustrating the process flow of job list preparation.

FIG. 4 is a flowchart illustrating a job sorting process and a generation of match matrix.

FIG. 5 is a flowchart illustrating a genetic algorithm process for use in task scheduling and resources allocation.

FIG. 6 is a flowchart illustrating the crossover process of the genetic algorithm.

FIG. 7 is a flowchart illustrating the mutation process of the genetic algorithm.

FIG. 8 is block diagram illustrating the output of the auto-assignment engine.

FIG. 9 is an example of the output produced by the auto-assignment engine

### DETAILED DESCRIPTION OF THE INVENTION

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, that execute via the processor of the computer or other programmable data processing apparatus, create means for implementing the functions/acts specified in the flowchart and/or block diagram block or blocks.

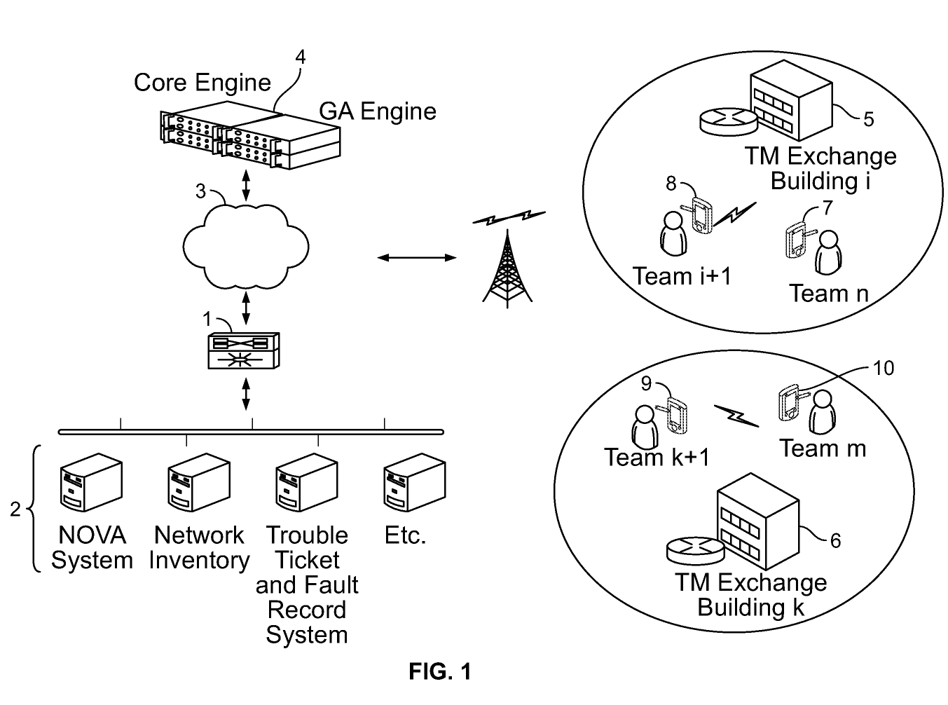

Referring to FIG. 1, a general architecture of the system for task scheduling and resources allocation is illustrated. The system includes a service server 1 coupled with at least one database 2, and a data mining engine 4 linked to the service server 1 and a plurality of electronic devices 7-10 of at least one repair center 5, 6 via a communication network 3. In operation, the data mining engine 4 retrieves information from the database 2 through the service server 1, processes the retrieved information via an improved genetic algorithm to obtain an optimum solution for the assignment of tasks, and then transmits the optimum solution to the repair center 5, 6.

Preferably, the service server 1 is a platform where complaints, trouble ticket and information are collected and the collected data are stored within the database. The service server 1 may include one or more heavy duty computers and any known devices or group of devices to provide sufficient capacity. In operation, the service server 1 is configured to process the collected data, to update the database, and to transmit the requested data to the data mining engine 4 via the communication network 3. The service server 1 can be operated via one or more operator or under the control of a fully automated intelligent system.

Preferably, the data mining engine 4 has a plurality of fully automated modules. Those modules include a data retrieval module configured to retrieve data from the database 2 of the service server 1, a weight assigning module configured to assign a weight value to the retrieved data, a task sorting module configured to sort the data according to each of their assigned weight value, a match matrix generator configured to generate a match matrix according to the sorted data, and a genetic algorithm module configured to apply the genetic algorithm process on the generated matrix to produce an optimum solution for the assignment of tasks. The data retrieval can be executed on a real time or periodical basis depending on the situation and the update rate of the database. Preferably, the data mining engine 4 retrieves and processes data from the service server 1 in every 30 minutes.

The repair center 5, 6 is a platform where repair teams/workers/engineers are stationed. Preferably, each repair team carries at least one electronic device 7-10 and the repair center 5, 6 has a central server that links the plurality of electronic devices 7-10. The central server is configured to receive and process the optimum solution from the data mining engine 4, and then transmit the solution to the plurality of electronic devices 7-10 for display. The plurality of electronic devices 7, 10 can be personal digital assistants (PDA), smart phones, tablets, computers, laptops, netbooks, phoblets, or any suitable means which are capable of processing data, displaying the data, and performing data transmission.

The communication network 3 is preferably a wireless network which may include but is not limited to a Code Division Multiple Access (CDMA) network, a General Packet Radio Service (GPRS) network for use in conjunction with Global System for Mobile Communications (GSM) network, and future third-generation (3G) networks like Enhanced Data rates for GSM Evolution (EDGE) and Universal Mobile Telecommunications System (UMTS). It is to be understood that although particular IP-based wireless networks have been described, the system could be utilized in any suitable type of wireless network. It should also be noted that the communication network 3 can be a wired network such as telephone network, cable television, internet access, or fiber-optic communication.

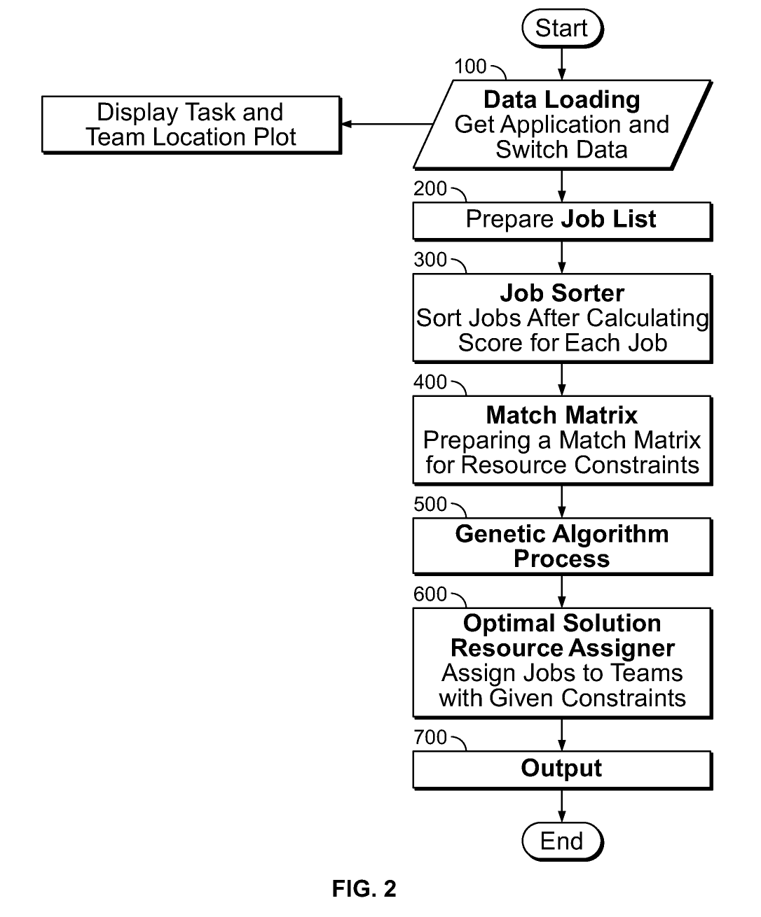

Referring to FIG. 2, an overview of the improved genetic algorithm process is illustrated therein. In step 100, the user triggers an input module to retrieve data relating to temporal constraint, procedural constraint, and resource constraints from a database. An example of each constraint is illustrated by the following Tables 1, 2, and 3.

| Item | Definition |
|---|---|
| Aging - Red | 10% before the MTTR target achieve |
| | (target based on SLA) |
| Aging - Yellow | 20% before the MTTR target achieve |
| Aging - Green | 30% before the MTTR target achieve |

Table 1 shows the elements of the temporal constraint.

| Item | Definition |
|---|---|
| Priority/SLA | P1, P2, P3, P4 |
| VVIP | Customer tagged as VVIP |
| Repeat Counter | TT created within 30 days |
| Priority | Customer priority complaint |
| complaint | |
| Source | Normal TT, Reactive save, A&R, proactive churn, |
| | Escalated regulatory |
| Infant | Trouble ticket created within 30 days from installation |
| breakdown | |
| Appointment | Customer request for appointment |

Table 2 shows the elements of the procedural constraint.

| Item | Definition |
|---|---|
| Travelling time | Time taken for repair team to complete the job |
| & distance | by minimizing travelling time and distance |
| Skillset | Ticket assignment based on team skillset (e.g.: |
| | UNIFI, Data, external Plant, Elite Team & others) in |
| | assurance and fulfilment. |
| Tools & test | Ticket assignment to the team with the right tool to |
| gear | get the job done.(Function disable until the platform |
| | ready) |
| Working hours | Ticket assignment based on working hours - possible up |
| (normal/ office | 24 hours/ shift based. |
| working hours) | |
| Network | Ticket are linked to trouble ticket during network outage |
| outage | |

Table 3 shows the elements of the resource constraint.

In step 200, a weight assigning module prepares a job list having information relating to the tasks assigned with their corresponding weight values based on the retrieved constraints. In step 300, a job sorter module sorts the tasks according to the weight value of each task. In step 400, a match matrix generator generates a match matrix for use in the genetic algorithm process. In step 500, a genetic algorithm module applies a genetic algorithm process on the generated match matrix. In step 600, the genetic algorithm module determines the optimum solution and applies the outcomes to a task assigner for assigning resources to each task. In step 700, the outcomes of the assignment are outputted to a display.

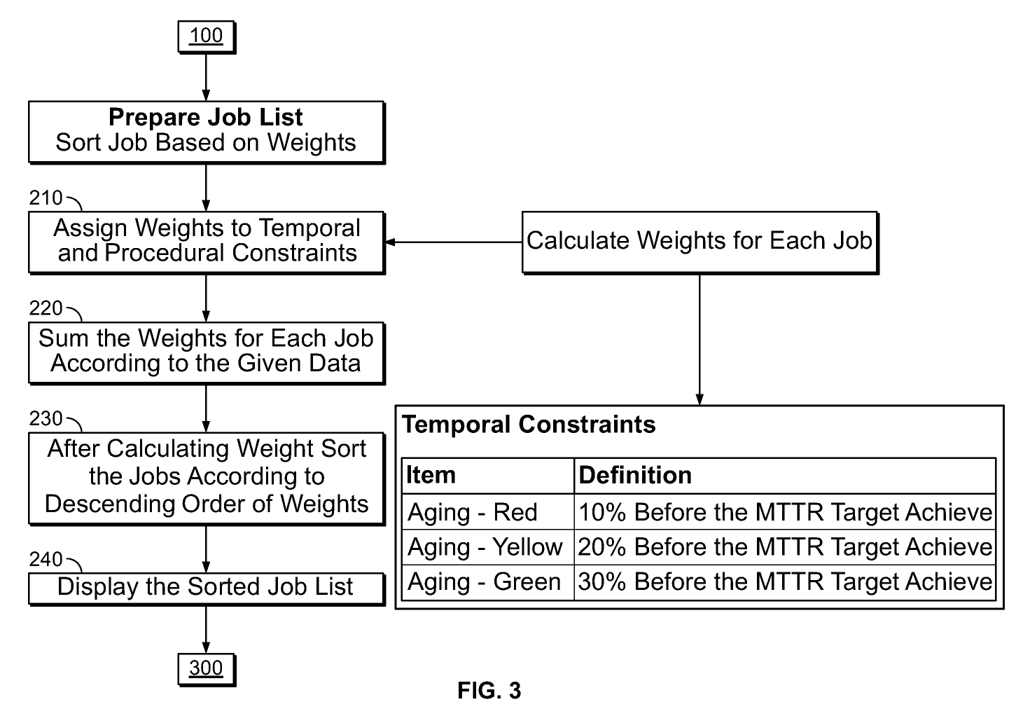

FIG. 3 depicts the process flow of job list preparation. In step 210, the weight assigning module assigns weights to each of the temporal and procedural constraints. In step 220, the module processes and sums up the weights for each task according to the given data. In step 230, the module sorts the tasks according to descending order of the assigned weight. In step 240, the module displays the job list in a sorted order.

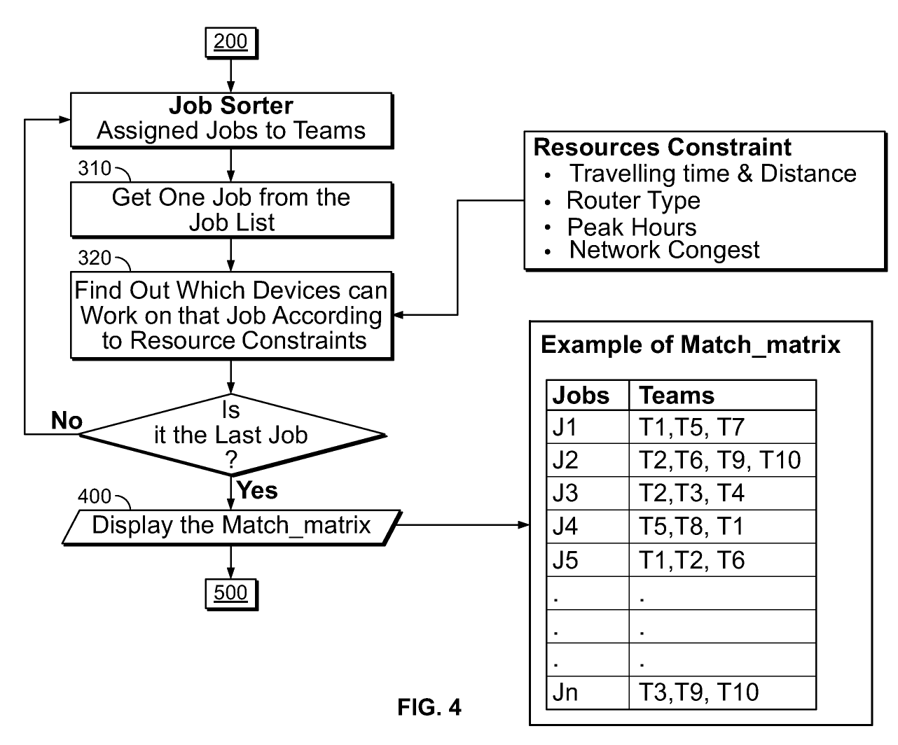

FIG. 4 depicts the process flow of job sorting process and the generation of match matrix. In step 310, the job sorter retrieves a task from the job list. In step 320, the job sorter determines the sort of resources that can be utilized in the retrieved task according to the resource constraints. Preferably, a looping process is applied to the job sorter until every task from the job list is assigned with at least one resource. In step 400, a match matrix generator generates a match matrix carrying tasks information with at least one resource assigned.

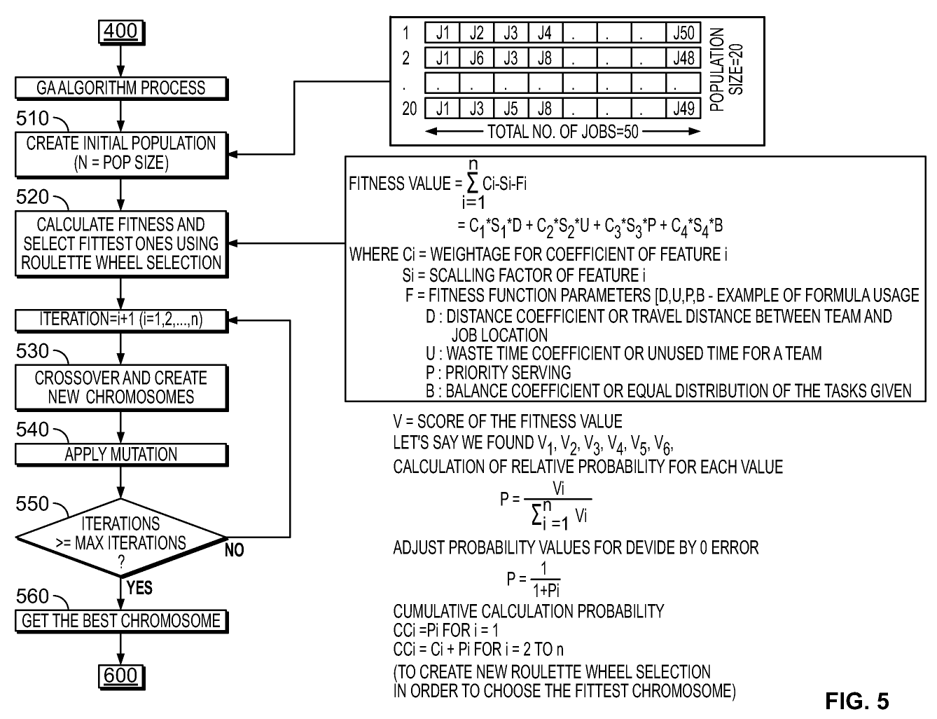

FIG. 5 shows the genetic algorithm process for use in task scheduling and resources allocation. In step 510, a genetic algorithm module creates an initial population in which each row of the initial population corresponds to one chromosome in a genetic algorithm, and each activity in the row of the initial population corresponds to a gene in the genetic algorithm. In step 520, the module calculates the fitness of every individual in the population and selects the fittest ones using roulette wheel selection. In step 530, the module applies a crossover process to create new chromosomes. In step 540, the module applies a mutation process to create mutated chromosomes. In step 550, the module applies an iteration process until a predetermined value is reached. In step 560, the module determines the optimum chromosome from the new population.

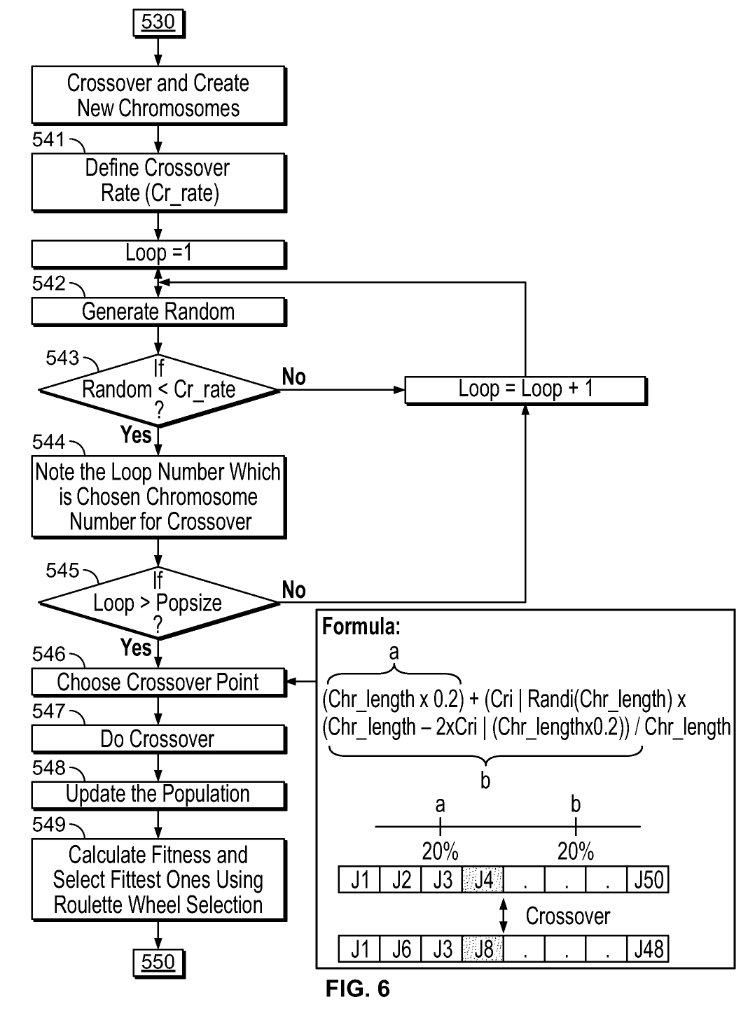

FIG. 6 shows the crossover process of the genetic algorithm. In step 541, the user defines the crossover rate. In step 542, the module generates a set of random numbers, in which the random numbers will be used as chromosome number for the crossover. In steps 543 to 545, the module applies a looping process until the set of random numbers is generated. In step 546, the user chooses at least one crossover point for the data to be swapped between two parent organisms. In step 547, the module performs the crossover process to generate a new chromosome. In step 548, the module updates the newly generated chromosome to the population. In step 549, the module recalculates the fitness and selects fittest ones using roulette wheel selection.

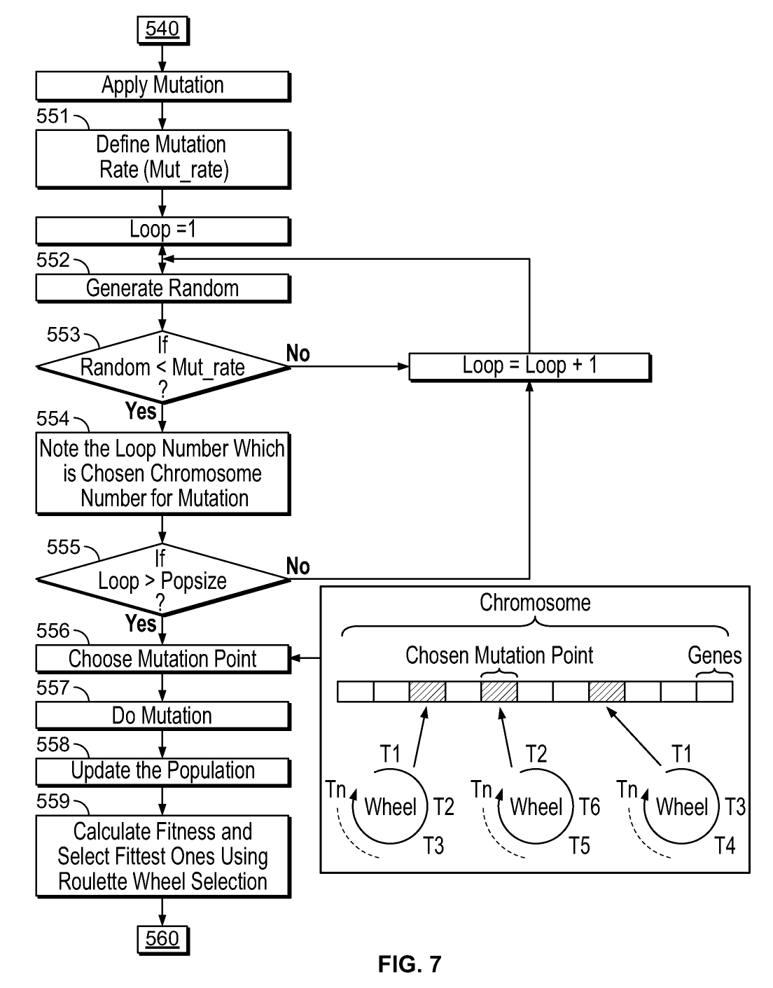

FIG. 7 shows the mutation process of the genetic algorithm. In step 551, the user defines the mutation rate. In step 552, the module generates a set of random numbers, in which the random numbers will be used as chromosome number for the mutation. In steps 553 to 555, the module applies a looping process until the set of random numbers is generated. In step 556, the user chooses at least one mutation point for the data in the corresponding gene to be replaced by a generated random number. In step 557, the module performs the mutation process to generate a mutated chromosome. In step 558, the module updates the mutated chromosome to the population. In step 559, the module recalculates the fitness and selects fittest ones using roulette wheel selection.

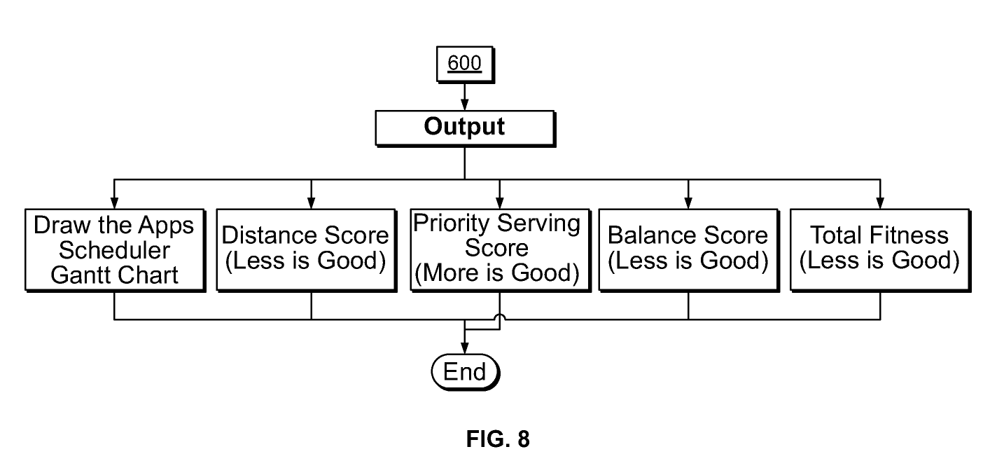

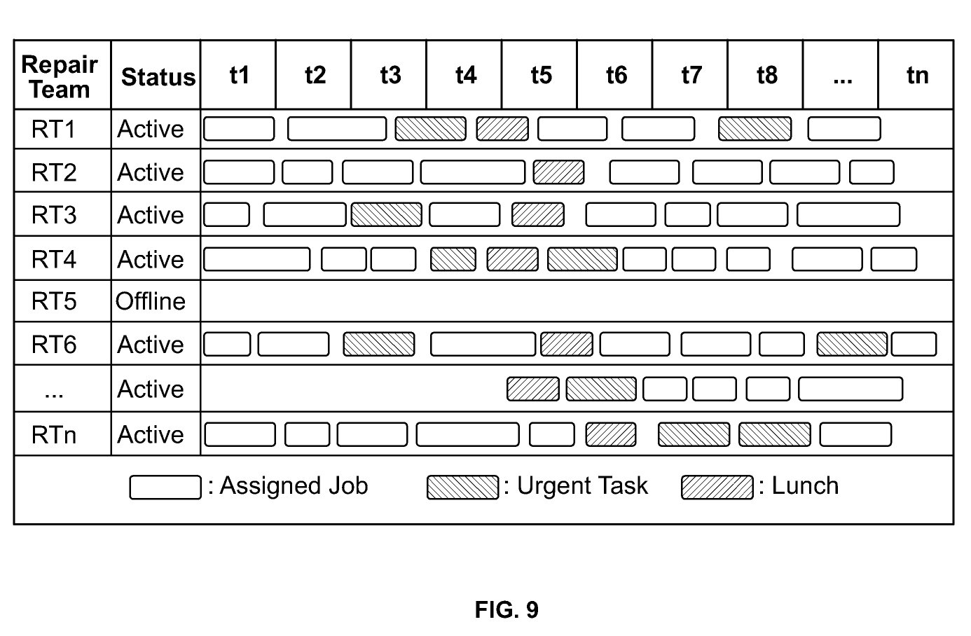

Referring to FIG. 8 and FIG. 9, the outputs of the method is illustrated. The output includes a task schedule chart that illustrates timeline, resources, priority for each activity. Indicators such as distance score, priority serving score, balance score, and total fitness value can also be presented along.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1. A computer implemented method for assigning tasks to groups of workers, comprising:
retrieving from a database, by a data retrieval module, information relating to a set of activities to be executed, a set resources to be utilized during execution of the activities, a set of constraints to be satisfied, and a set of objectives to be accomplished;
assigning, by a weight assigning module, a weight value according to the set of constraints for each activity of the set of activities;
sorting, by a task sorting module, the activities of the set of activities according to each of their respective weight values;
assigning, by the task sorting module, at least one resource to each activities of the set of activities;
generating, by a match matrix generator, a matrix including a list of the set of activities and the at least one resource assigned to each of the activities of the set of activities; and
applying, by a genetic algorithm module, a genetic algorithm process on the generated matrix to produce an optimum solution for assignment of the at least one resource to each activity of the set of activities.

2. The method according to claim 1, wherein applying the genetic algorithm process with the genetic algorithm module includes
generating a plurality rows of initial population, wherein each row of the initial population corresponds to one chromosome in a genetic algorithm, and each activity in the row of the initial population corresponds to a gene in the genetic algorithm.

3. The method according to claim 1, comprising sorting, by the task sorting module, the activities of the set of activities according to each of their respective weight value in a descending order.

4. The method according to claim 9, wherein the chromosome crossover process comprises:
defining a crossover rate;
randomly assigning a chromosome value for the chromosome crossover process;
defining a crossover point;
executing a recombination process of genes based on defined parameters; and
updating a recombined chromosome to the initial population.

5. The method according to claim 9, wherein the mutation process comprises the steps of:
defining a mutation rate;
randomly generating a value for the gene;
defining a mutation point;
executing a replacement of the generated value according to a defined parameter; and
updating a mutated chromosome to the initial population.

6. The method according to claim 10, wherein the output process includes:
generating a task schedule chart which illustrates timeline, resources, and priority for each activity of the set of activities; and
computing a distance score, a priority serving score, a balance score, and a total fitness value.

7. An automated system for assigning tasks to groups of workers, comprising:
a service server connected to a communication network, and coupled with at least one database; and
a data mining engine connected to the service server via the communication network, and configured to:
retrieve data from the at least one database,
assign a weight value to the retrieved data,
sort the retrieved data according to each of their respective weight values,
process the sorted data via a genetic algorithm to produce an optimum solution for task assignment, and
transmit the optimum solution to at least one electronic device via the communication network.

8. The system according to claim 7, wherein the data mining engine includes
a data retrieval module configured to retrieve the data from the at least one database of the service server.

9. The method according to claim 2, wherein applying the genetic algorithm process with the genetic algorithm module includes:
forming a fitness function based on the initial population to acquire fitness values of the chromosomes;
selecting an optimum fitness value by using roulette wheel selection; and
performing a chromosome crossover process and a mutation process to generate new and mutated sets of chromosomes.

10. The method according to claim 9, wherein applying the genetic algorithm process with the genetic algorithm module includes:
executing an iteration process on the chromosome crossover process and the mutation process until a predetermined maximum repetition value is reached so as to obtain an optimum chromosome; and
outputting an outcomes of the genetic algorithm process to a display unit.

11. The system according to claim 7, wherein the data mining engine includes a weight assigning module configured to assign the weight value to the retrieved data.

12. The system according to claim 7, wherein the data mining engine includes a task sorting module configured to sort the retrieved data according to each of assigned weight values.

13. The system according to claim 7, wherein the data mining engine includes a match matrix generator configured to generate a match matrix according to the sorted data.

14. The system according to claim 13, wherein the data mining engine includes a genetic algorithm module configured to apply a genetic algorithm process on the generated match matrix to produce the optimum solution for the task assignment.

15. A non-transitory computer-readable medium storing instructions for assigning tasks to groups of workers that are executable by a processor, wherein execution of the instructions by the processor causes the processor to:
retrieve from a database, by a data retrieval module, information relating to a set of activities to be executed, a set resources to be utilized during execution of the activities, a set of constraints to be satisfied, and a set of objectives to be accomplished;
assign, by a weight assigning module, a weight value according to the set of constraints for each activity of the set of activities;
sort, by a task sorting module, the activities of the set of activities according to each of their respective weight values;
assign, by the task sorting module, at least one resource to each activities of the set of activities;
generate, by a match matrix generator, a matrix including a list of the set of activities and the at least one resource assigned to each of the activities of the set of activities; and
apply, by a genetic algorithm module, a genetic algorithm process on the generated matrix to produce an optimum solution for assignment of the at least one resource to each activity of the set of activities.
